(19) United States
(12) Patent Application Publication
(10) Pub. No.: US 2026/0054162 A1
(43) Pub. Date: Feb. 26, 2026

(54) Reduced Power Consumption on Battery Operated Follower Devices

(71) Applicant: Microsoft Technology Licensing, LLC, Redmond, WA (US)

(72) Inventors: Tero Juhani PATANA, Kirkland, WA (US); Shuoqi Scott WANG, Redmond, WA (US)

(73) Assignee: Microsoft Technology Licensing, LLC, Redmond, WA (US)

(21) Appl. No.: 18/812,138

(22) Filed: Aug. 22, 2024

(51) Int. Cl. A63F 13/235; G06F 1/3206; G06F 1/3234

(52) U.S. Cl. CPC A63F 13/235; G06F 1/3206; G06F 1/3234

(57) ABSTRACT

This document generally relates to matching power usage on follower devices to a level of user interaction. One example includes a processor configured to run an interactive application and to proactively identify active periods where a user interacts with a presentation of the interactive application and inactive periods where the user does not interact with the presentation. The example includes a communication component configured to send a first set of parameter values to a follower device for use during the identified active periods and to send a second set of parameter values to the follower device during the identified inactive periods that cause the follower device to use a relatively lower amount of power.

### BACKGROUND

Users engage many types of input/output devices to interact with the electronic world. Power usage by these devices, especially battery-operated devices, is an important consideration. From a macro perspective, conserving power is important for the common good. From a micro perspective, conserving power makes the device last longer on a given battery charge. User satisfaction with the device tends to be diminished if the device stops working because the batteries go dead.

### SUMMARY

This patent generally relates to matching power usage on follower devices to a level of user interaction. One example includes a processor configured to run an interactive application and to proactively identify active periods where a user interacts with a presentation of the interactive application and inactive periods where the user does not interact or is not expected to interact with the interactive presentation. The example includes a communication component configured to send a first set of parameter values to a follower device for use during the identified active periods and to send a second set of parameter values to the follower device during the identified inactive periods that cause the follower device to use a relatively lower amount of power than the first set of parameter values.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1A-1I illustrate an example video game scenario in which some of the present concepts relating to matching power usage on follower devices to a level of user interaction can be employed in accordance with some implementations.

FIG. 2 illustrates an example system that can implement matching of power usage on follower devices to a level of user interaction in accordance with some implementations.

FIGS. 3-4 illustrate example methods that can match power usage on follower devices to a level of user interaction in accordance with some implementations.

### DETAILED DESCRIPTION

### Overview

Input/output devices are utilized to present content to users and receive input from users. Providing this input/output functionality consumes power. Providing higher levels of functionality uses more power than providing lower levels of functionality. For instance, presenting visual content at a higher refresh rate uses more power than presenting visual content at a lower refresh rate.

Many input/output devices are battery powered. Conserving battery resources so that the input/output devices are functioning when the user wants to use them increases user satisfaction. Many input/output devices perform a follower role where they present content and/or receive input for another device (e.g., a host device). For instance, in the follower role the input/output devices can receive content from the host device. The input/output devices can present the content to a user, such as visually, audibly, and/or haptically. These input/output devices and/or other input/output devices can receive user input and send the user input to the host device to allow user interaction with the content at the host device.

In these scenarios, the host device runs an application and generates the content. The host device receives the user input and updates aspects of the application based upon the user input. Thus, the host device can be viewed as a ‘context-aware device’ because it can identify relationships between the content and the user input. Stated another way, the context-aware device can determine when and to what extent user interaction is involved during particular periods when the application runs. In contrast, the input/output devices can be viewed as follower devices that simply present content and/or receive and relay user input. Thus, the follower devices have no ability to correlate content presentation and user input.

In many scenarios, presentation of content and user input is not uniform for the duration of the application. Instead, as the application prepares to run, runs, and/or ends, some periods may allow user interaction and some periods may not allow user interaction. The context-aware device can identify what functionality is appropriate for individual periods of the application. The context-aware device can use this information to command or recommend performance levels for individual follower devices based upon the functionality during these periods. This allows the context-aware device to provide a technical solution of saving power consumption by matching follower device performance to user-interaction associated with individual instances or periods of the running application.

### Example Use Case Scenarios

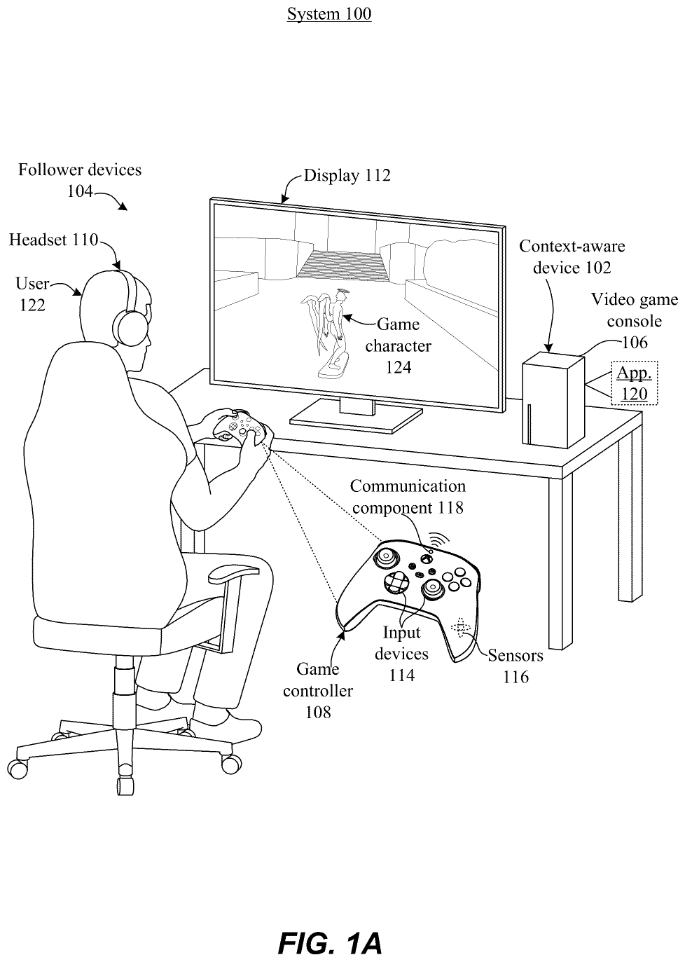

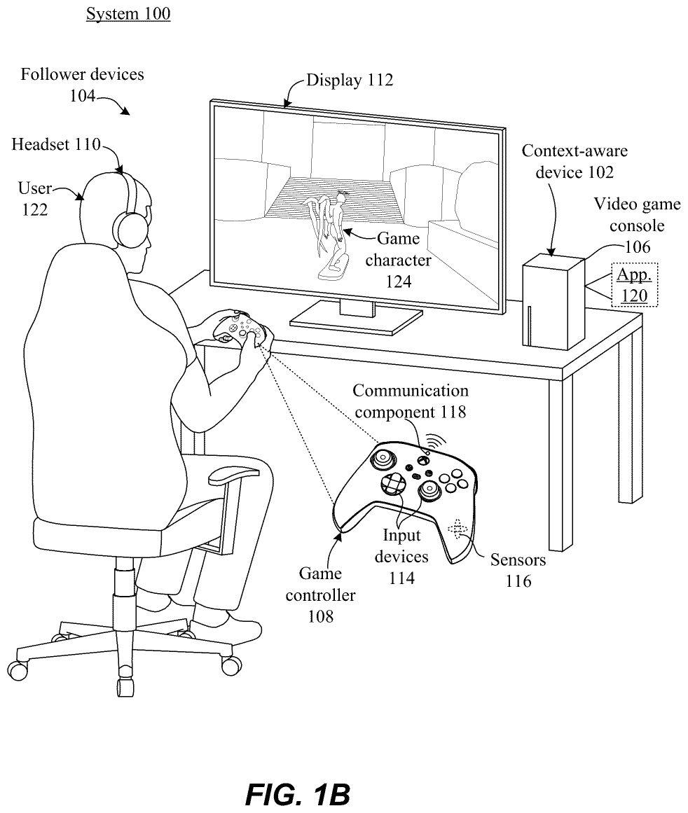

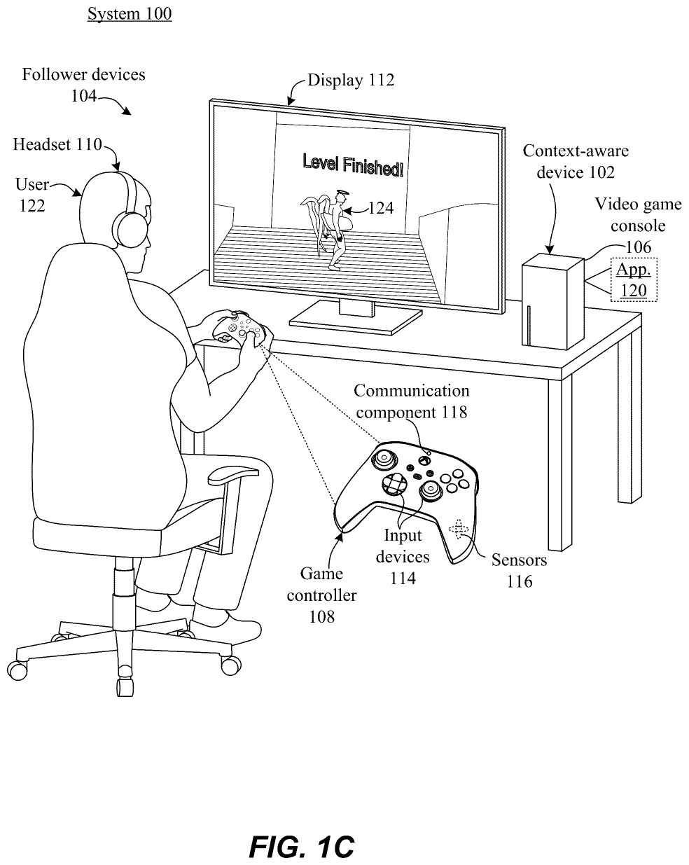

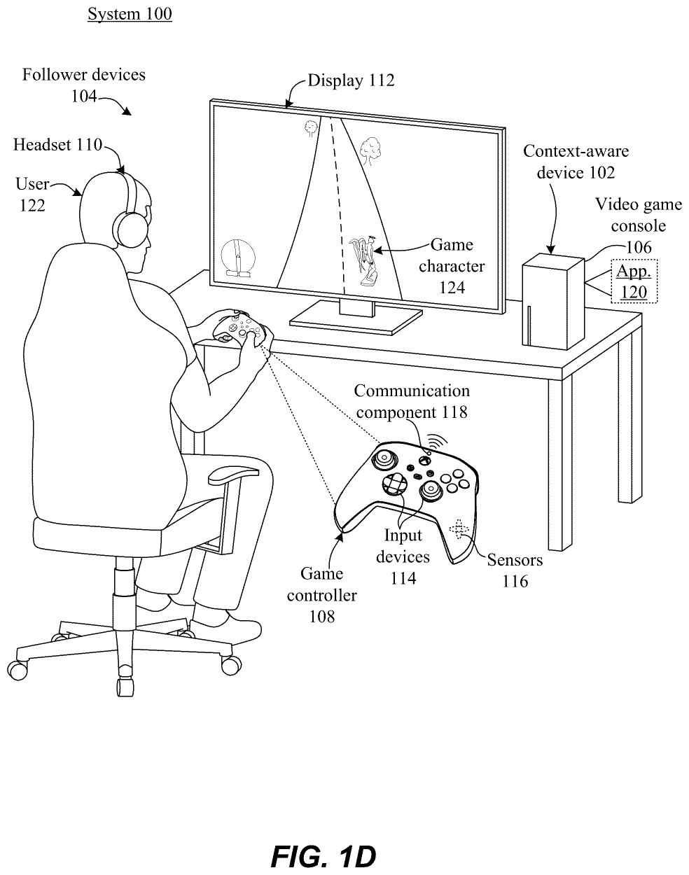

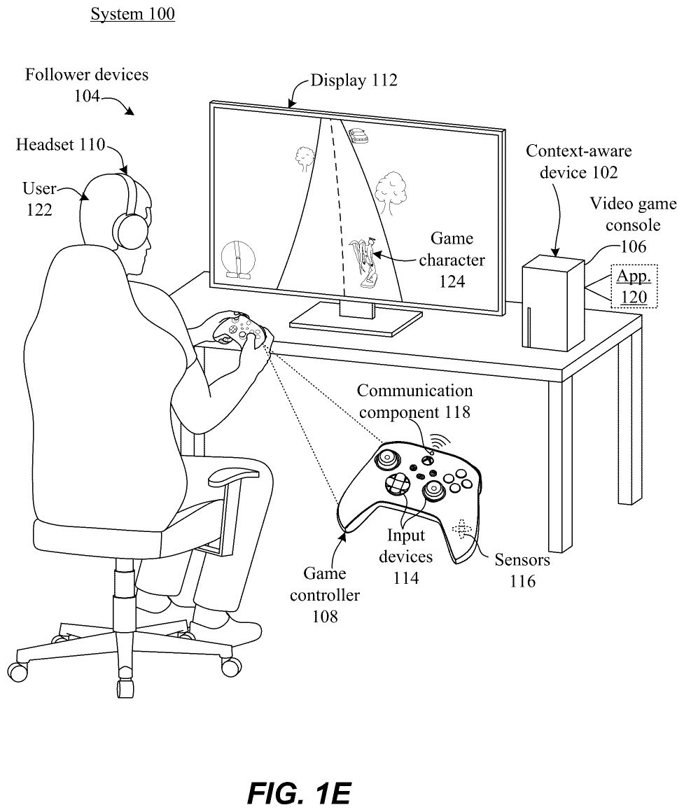

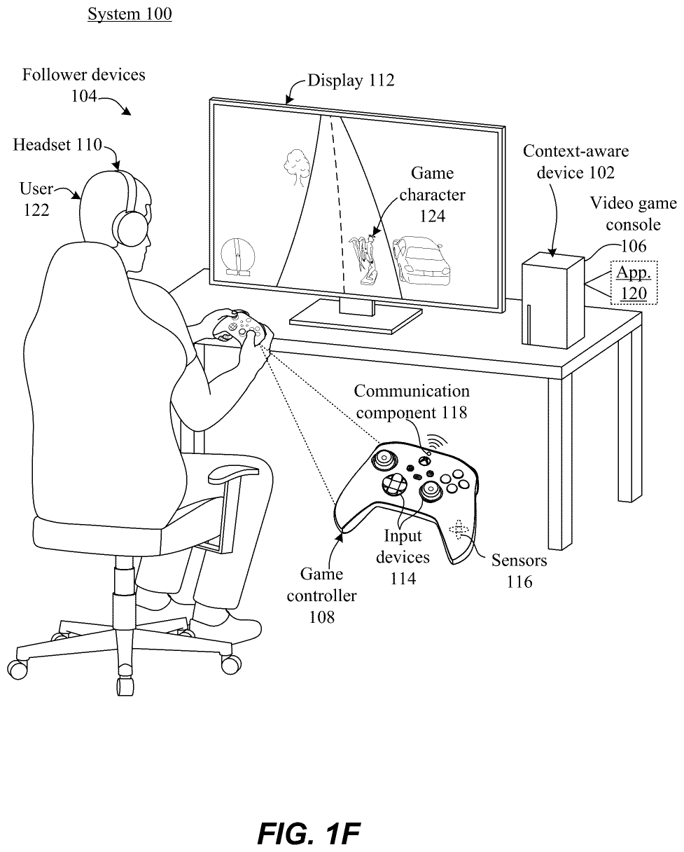

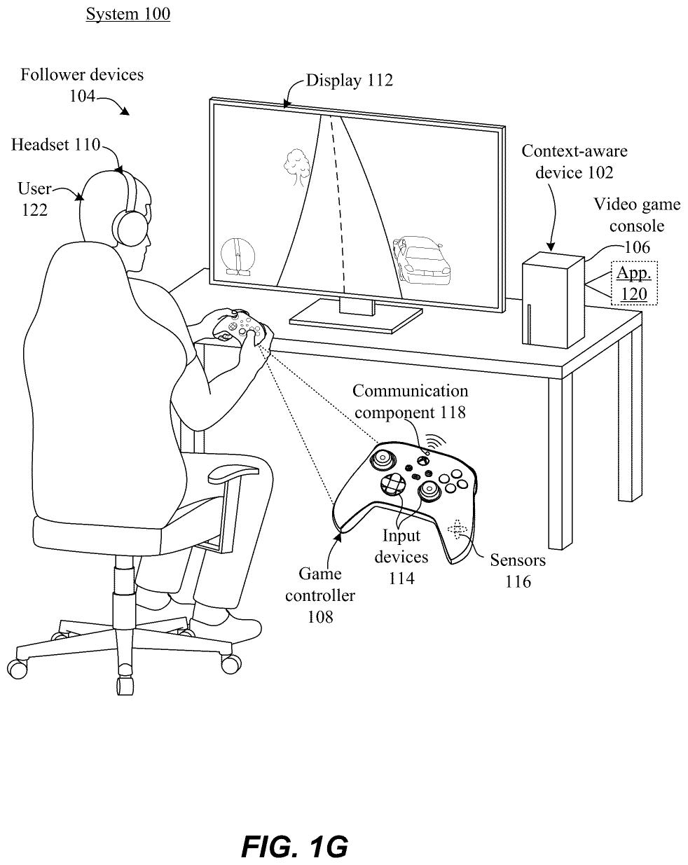

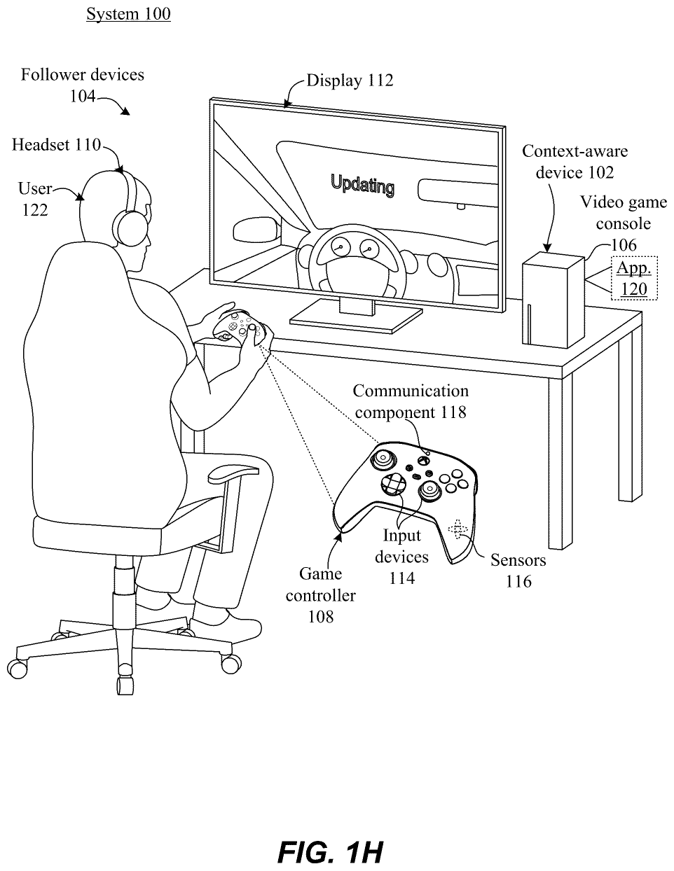

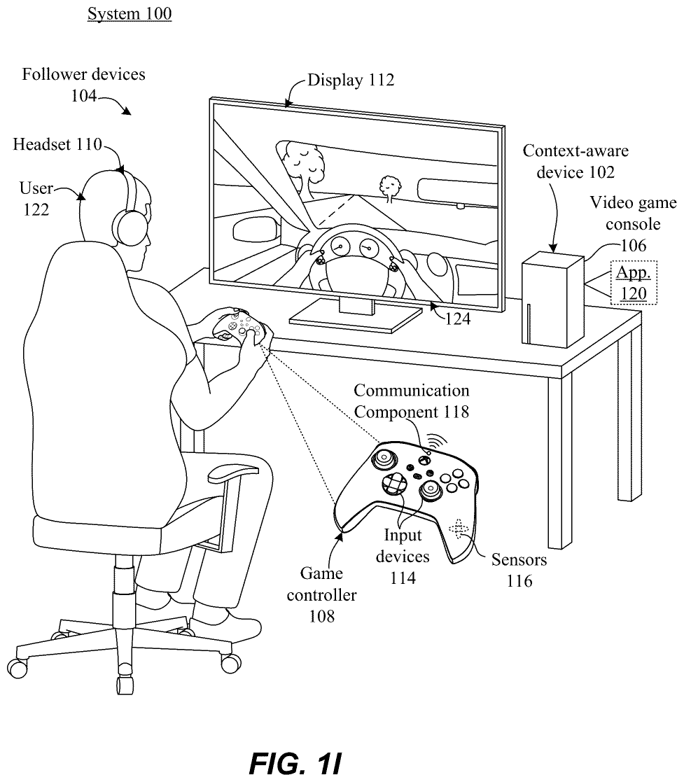

FIGS. 1A-1I collectively show a use case scenario involving some of the present concepts implemented on an example system 100. This system includes a context-aware device 102 and follower devices 104. In this case, the context-aware device 102 is manifest as an entertainment console, such as a video game console 106. The context-aware device 102 could also be manifest as a general-purpose computer, such as a personal computer, an android-based computer, or an Apple brand computer, among others.

In this case, the follower devices 104 include a battery-powered video game controller 108, a headset 110, and a display (e.g., monitor or TV) 112. These follower devices consume power. Conserving power is desirable from both a cost and resource usage perspective. In some configurations, some or all of the follower devices are battery operated (e.g., have a finite amount of power). This adds more reasons to conserve power. For instance, having the battery go dead while the user is using the follower device is very frustrating to the user, disruptive to the user flow, and obviously diminishes the user experience.

The follower devices 104 can include sub-components. For instance, the battery-powered video game controller (hereinafter may be shortened to “game controller”) 108 can include input devices 114, sensors 116, and a communication component 118. Similarly, the display can include visual components (e.g., LEDs, OLEDs, etc.), speakers, microphones, a communication component etc., which are not specifically designated in the FIGS. Also, headset 110 can include speakers and microphones, a communication component, etc., which are not specifically designated in the FIGS. Operation of these sub-components consumes power. The follower devices' communication components 118 can communicate with the context-aware device 102. This communication consumes power. Sensors 116 consume power during operation to generate sensed values. The communication component 118 consumes power conveying these sensed values to the context-aware device 102. The faster the rate at which the sensed values are communicated to the context-aware device, the more power consumed.

In many cases, the rate at which power is consumed relates to how the sub-components are operated (e.g., their operational parameters). For example, operating the sensors to obtain sensed values more often and conveying the sensed values to the context-aware device more often uses power at a faster rate than sensing less often and conveying the sensed values less often. The sensing rate and the communication rate are examples of parameters that affect power usage. Higher parameter values (e.g., a faster communication rate) use more power than lower parameter values (e.g., a slower communication rate).

An application 120 can run on the context-aware device 102. The application can generate content (e.g., data) on the context-aware device 102. The context-aware device can communicate the content to the follower devices 104. The follower devices can present the content to a user 122. For instance, content from the application can be presented visually on display 112, audibly on headset 110, and/or haptically on game controller 108. Similarly, user input relative to the presented content can be received from the user by the follower devices 104 and conveyed to the context-aware device 102 for use by the application. For instance, relative to the game controller 108, the sensors 116 can sense user input in the form of movement and/or orientation information of the game controller. Input devices 114 can receive user input in the form of commands to control the application. These user inputs can be conveyed to the context-aware device 102 by the communication component 118.

Note however that as explained below, the presentation of the user content and/or the ability of the user to interact with the application can vary from instance to instance or period to period that the application runs. This aspect is explained below starting with FIG. 1A.

FIGS. 1A and 1B show the user 122 interacting with video game content presented on display 112. As mentioned above, this content is generated by application 120 on context-aware device 102 and sent to the display for presentation. This scene represents a relatively highly interactive situation where video game content generated by the application is presented to the user and the user controls aspects of the presented content. In this case, the user controls balance and movement of game character 124 on the presentation. This input can be achieved through a combination of activating input devices 114 and controlling the orientation of the game controller, which is sensed by the sensors 116. Though not shown, the user can also shoot arrows at various targets, raise and lower shields, etc. by activating other input devices 114.

At this point, the user wants relatively high performance from all aspects of the gaming experience provided by the application 120 on the context-aware device 102. For instance, the user wants to see the position of the game character 124 on the hoverboard. The user wants to make slight adjustments to the position of the game character by making slight orientation adjustments to the game controller 108. The user wants these adjustments to be reflected on the game character 124 as soon as possible. This entails sensing by the sensors 116 and communicating the sensed value to the context-aware device by the communication component 118 as quickly as possible. This input is then incorporated by the application, which generates corresponding adjustments to the game character that are reflected in the presentation on the display. Similarly, the user wants these updates to be reflected in the presentation as soon as possible so that it feels life-like. This can be referred to as ‘low latency input’ (e.g., the user wants their input to be incorporated by the application as quickly as possible). For purposes of explanation the whole presentation, input, updated presentation, can be referred to as ‘cycle time’. A fast cycle time allows the user to successfully balance on the hoverboard and steer the hoverboard toward the stairway as shown in FIG. 1B and complete this game level as shown in FIG. 1C. In contrast, slower cycle times (e.g., slower reflection of user input in the game character) may cause user dissatisfaction. For instance, if there is delay in updating the position of the game character when the user leans to one side (by adjusting the orientation of the game controller 108) to steer the hoverboard, the user may lean farther. This may cause the game character to fall off of the hover board or steer off the intended course and/or crash and not reach the stairway and thus not complete the level.

Thus, in this period of the application 120, the user experience depends upon fast adjustments/updates between the game controller 108 and the reflection of those adjustments in the presentation (e.g., fast cycle times). During this period of the application, slower adjustments can diminish the user experience. Thus, during this period the user experience is enhanced by operating the follower devices 104 at higher operational parameter values even if this results in high power consumption. For instance, the sensors 116 can be operated to sense information about the movement and orientation of the game controller 108 at a high rate. Similarly, the communication component 118 can be operated to convey the sensed values to the context-aware device 102 at a high rate. The display 112 can operate at a high refresh rate so changes in the scene (e.g., user position in this example) are reflected on the display as quickly as possible.

FIG. 1C shows the user having successfully navigated the level of FIGS. 1A and 1B. At the period during this interval between levels (e.g., between completion of the last level and the beginning of the next level), the application is performing various ‘housekeeping’ functions including loading instructions and data relating to the next level from storage to memory. These housekeeping functions take time to complete, and the level of user interaction is reduced during this period. For instance, the application may define a minimum of 10 seconds, for example, for housekeeping functions between levels. Alternatively, the application may track the progress of the housekeeping functions so an approximate completion time is known or discernable.

In this example, during this period the user 122 has limited options for interacting with the follower device. The user can do nothing and the game character 124 will remain on the stairs or the user can activate an input device to move the game character forward towards the opening. However, in this example, the application 120 predefines the minimum time for the game character to walk up the stairs as 10 seconds, for instance. Thus, the cycle time does not affect the user experience, and thus a slower cycle time essentially produces the same user experience as a fast cycle time during the inactive periods while using less battery power than fast cycle times.

The term ‘inactive periods’ is used herein relative to the active periods. In the active periods, the user experience is enhanced by fast cycle times (e.g., feedback from the follower device to the context-aware device and fast incorporation of that feedback into the updated content sent to the follower devices for presentation to the user). In contrast, during the inactive periods user input may not be allowed (e.g., may not do anything) or user input may occur at the application and affect the subsequent content presented to the user. However, in this latter case, the rate at which this occurs has little or no bearing on the user experience. For instance, as mentioned, the game character is limited to a very slow rate at which it can move forward so cycle time becomes basically irrelevant to the user experience. For instance, a sensing and communication rate of 0.01 seconds would essentially produce the same user experience as a sensing and communication rate of 1.0 second, but would use much more power.

In this example, during this inactive period the user can only move forward or stay in place. As such, sensor input is not germane at this point. Stated another way, movement and/or orientation of the game controller is not accepted/utilized as user input for this period of the running application. Further, only one input device (e.g., the one that controls forward movement) can provide user input that is accepted and utilized as user input for this period of the running application 120. Thus, the application is only interested in (e.g., is going to respond to) one control option (e.g., stationary or forward). The game controller can be instructed to (or permitted to) power down other unused inputs.

During this inactive period, the rate at which the input devices 114 sense user input is not particularly germane to the user experience. For instance, whether the input devices obtain and deliver user input once every 1/100^{th} of a second or once every second, for example, will not have any discernable difference to the user experience. Further still, the rate at which the user input is conveyed from the video game console 106 to the context-aware device 102 is not particularly germane to the user experience. Again, whether the communication component 118 communicates the user input to the context-aware device 102 once every 1/100^{th} of a second or once every second, for example, will not have any discernable difference to the user experience. Either way, the game character 124 will remain stationary or slowly move up the stairway while the application completes the housekeeping functions. The rate is predefined by the application to take at least 10 seconds in this example. Thus, during the inactive period other factors control the user experience rather than the cycle time.

Thus, unlike the active period of FIGS. 1A and 1B, where the user experience is enhanced by operating the follower devices 104 at higher operational parameter values, during the inactive period of FIG. 1C, the follower devices can be operated at relatively lower operational parameter values without diminishing the user experience. This realization is leveraged by the present concepts to provide a technical solution that reduces power usage by the follower device without diminishing the user experience. Instead, this technical solution conserves battery power by reducing power consumption during these inactive periods. The reduced battery consumption results in little or no reduction in the user experience. However, the technical solution provides a great enhancement to the user experience by prolonging battery life on the follower devices by reducing their battery usage during the inactive periods. This reduces the likelihood of the follower device going dead (e.g., battery running out of power) during use. Thus, the present concepts both extend the battery life of the follower devices and reduce the user's tendency to worry about the follower device going dead during a game. This user worrying can itself diminish the user experience.

System 100 can implement these technical solutions via the context-aware device 102. The context-aware device can identify input information relating to the application 120 (e.g., whether the application is expecting user input in a given period). This identification can indicate whether cycle time is a determining factor for individual periods when the application runs. The context-aware device 102 can then provide operational parameter values to one or more of the follower devices 104 that match the individual periods of the application (e.g., higher operational parameter values when cycle time is controlling and lower operational parameter values when cycle time is not controlling). For instance, in relation to the game controller 108, the set of operational parameter values for the active period may define that all input devices are on, all sensors sense every 0.01 seconds, and the communication component convey signals from the input devices and the sensors every 0.01 seconds. In contrast, in this example the set of parameter values for the inactive period may turn all input devices off except for the one that controls forward movement, turn all sensors off, and set the communication rate at a reduced rate, such as 1.0 second or even 10 seconds. This will substantially reduce power consumption by the game controller compared to the active period set of parameter values. During the inactive periods, communication between the context-aware device and the follower device may occur less frequently than during the active periods. However, in at least some implementations, the communicative relationship between the devices is maintained during the inactive periods. Stated another way, the follower device remains attached to the context-aware device so that the devices do not have to re-pair or otherwise re-initialize a communication relationship when transitioning to the next active period.

FIG. 1D shows the user starting a new game level. In the new level, the user needs to provide multiple inputs via the game controller's input devices 114 including steering, leaning, picking up tokens, etc. to control the game character. Thus, during this period a quick cycle time between the user input and the time the user input is reflected in the application's presentation is important to the user experience. Accordingly, the context-aware device 102 can instruct individual follower devices 104 to operate according to a set of higher power usage operational parameter values (e.g., similar to those of FIGS. 1A and 1B and faster than those of FIG. 1C).

FIGS. 1E-1F collectively show the user 122 continuing to control the game character 124 as it progresses through the game level introduced in FIG. 1D. The context-aware device 102 continues to instruct the follower devices 104 to operate according to a set of higher power usage operational parameter values. In this scenario, the user guides the game character along the road toward a car parked along the road.

In this example, as shown in FIG. 1G, the user controls the game character to get into the car. Getting into the car changes the trajectory of the game (e.g., starts a new level or sub-level). As such, the application has to perform some housekeeping functions, such as bringing some additional instructions and/or data to memory. During this delay (e.g., inactive period) the user cannot control the game character. Accordingly, to save power usage on the game controller 108, the context-aware device 102 causes the game controller to decrease power usage. The context-aware device 102 sends a set of low power usage operational parameter values to the game controller 108 that decreases its power consumption.

Further, the application 120 generates a static image shown in FIG. 1H during this period. Accordingly, the context-aware device 102 sends a set of low power usage operational parameter values to the display 112 for use during this inactive period. With a static image, the refresh rate can be lowered without diminishing the user experience. Lowering the refresh rate lowers power consumption.

FIG. 1I shows the static image of FIG. 1H replaced with an active dynamic image on the display 112. Slightly before the change from static image to dynamic image, the context-aware device 102 sends sets of higher power usage operational parameter values to the display 112 and the game controller 108 for use during this period. Thus, the context-aware device 102 matches power use on the follower devices 104 to meet user expectations for a particular period. This decreases energy consumption and thus increases battery life with little or no effect on the user experience. For instance, the game controller 108 functions fast when the user 122 can control the game character 124 and slower when the user has reduced or no control of the game character. Similarly, the display refresh rate is fast during dynamic interactive periods and slower during static inactive periods. This also occurs without lag, instead the changes can be made proactively as the application 120 approaches a period change.

Note that the context-aware device 102 can make these parameter value changes corresponding to active and inactive periods seamlessly and without user involvement. Further, there is no lag introduced into the system (e.g., slow response times) because the context-aware device 102 can proactively set the parameter values right as periods transition from active to inactive and inactive to active.

To summarize some of the aspects introduced above, many video game applications have inactive periods, such as cutscenes where the player is not required or allowed to use the game controller, or where only a limited set of inputs are processed by the application (e.g., pressing the “A” button fast-forwards the scene, but other application inputs would be ignored). The present implementations can proactively identify these inactive periods and instruct the follower devices to operate at a reduced functionality. The reduced functionality can reduce power consumption on the follower devices. The reduced functionality can be defined via a set of parameter values. When the inactive period, such as the cutscene, ends these implementations instruct the follower devices to operate at a higher functionality. The higher functionality can be defined with a different set of parameter values.

Note that these periods are identified proactively relative to a currently executing application. The follower devices 104 are then controlled proactively to align their functionality with the period of the application 120. This proactive identification and control can be contrasted with traditional passive power saving techniques that power down devices after a predetermined period of inactivity. These traditional passive power saving techniques do not offer the same power savings as the present concepts. For instance, reliance on elapsed time before powering down means that power is used during at least part of the inactive period before the time threshold is reached. In many cases, the threshold may be longer than the inactive period and thus no power saving is realized. Further, these previous techniques rely on the user to ‘wake up’ the device, such as by moving it. Thus, initial user input when the game returns to the active period (e.g., starts running again) may not be detected by the game controller and/or may not be communicated to the video game console while the device transitions from the sleep or inactive state to the active state. This is often referred to as ‘lag.’ Thus, these previous techniques do not offer as much power savings as the present concepts and the previous techniques introduce lag into the system which diminishes the user experience. An ‘inactive state’ reduces power consumption compared to an active state but reduces the functionality compared to the active state. For instance, ‘sleep’ is an inactive state that offers some power savings with some functionality reduction. This range is bounded by the fully ‘off’ inactive state at one end and the fully ‘on’ active state at the other end. Other inactive states, such as sleep, fall between these two bounds and trade some power savings for some functionality reduction. In contrast to traditional techniques, the present concepts identify and leverage instances where the power savings can be achieved without the functionality reduction being noticed by the user and/or otherwise reducing the user experience.

An additional disadvantage to traditional passive time-based power saving modes is that they shut down the entire device which can be irksome for users who may still need to periodically interface in a limited fashion with the content (e.g. pushing a button to move to the next episode after the follower device has been inactive for all of the previous episode, reading a long form piece of static content like a digital book that requires periodically scrolling to advance or an input to keep the device “awake”). In contrast, the present concepts provide customized control of individual parameters relating to the follower device (e.g., needed aspects can remain active while unneeded aspects can be operated at a lower power).

The present implementations can proactively instruct the game controller 108 to return to the active state right before or right as the application 120 transitions from the inactive state/period to the active state/period. As such, with the present concepts, the game controller 108 is immediately ready when the user wants to use it when the active period starts and immediately changes to a power saving state as soon as the application game state changes to an inactive period.

The relative terms ‘active state’ and ‘inactive state’ are utilized in this document for purposes of explanation. Many examples are described above and below of novel techniques for saving power in an inactive state. Note that the present concepts can also be applied within the active state. For instance, in some situations, the application is in an active state, but does not rely on low latency (at least compared to other scenarios). In such cases, the follower devices can be controlled to conserve power without diminishing the user experience. For instance, during active periods of a fast-paced racing or shooter game the user experience depends upon relatively fast input detection rates to get the user input to the application, which responsively generates updated content. For example, delays longer than 10 milliseconds (ms) may diminish the user experience. In contrast, a game such as chess has active periods where the application is waiting for user input. However, the follower device could be operated in a power saving manner (e.g., slower), such as causing delays of 0.1 second or more without creating a discernable difference to the user.

In the example above, the context-aware device 102 selects the parameter values for the follower devices 104 based upon the state of the application 120. However, the context-aware device 102 is aware of, and can also utilize other factors, such as external factors when determining which parameter values to employ. For instance, if the internet connection is slow or is interrupted, and the application 120 is waiting to transmit or receive packets that it needs, the context-aware device 102 can switch the operational parameter values from high values to low values until the packets are transmitted/received.

As used herein ‘cycle time’ can include anything that contributes to the feedback loop. For instance, cycle time can include user responses to stimuli (e.g., display output) by activating input devices on the follower device. The cycle time can include the follower device detecting the input's activation (e.g., delay from polling speed, or delay from other blocking processing) and/or transmission of the detected inputs from the follower device to the context-aware device and hence the running application. The cycle time can also include the application's update of the game state and the presentation of this updated state on one or more of the follower devices. Significant power usage on the follower devices relates to parameters such as the how fast the user inputs are detected by the follower device and conveyed to the context-aware device and how fast the updated game state is presented to the user, among others. Thus, controlling these parameter values during inactive periods can provide significant power saving without diminishing the user experience.

### Example Systems

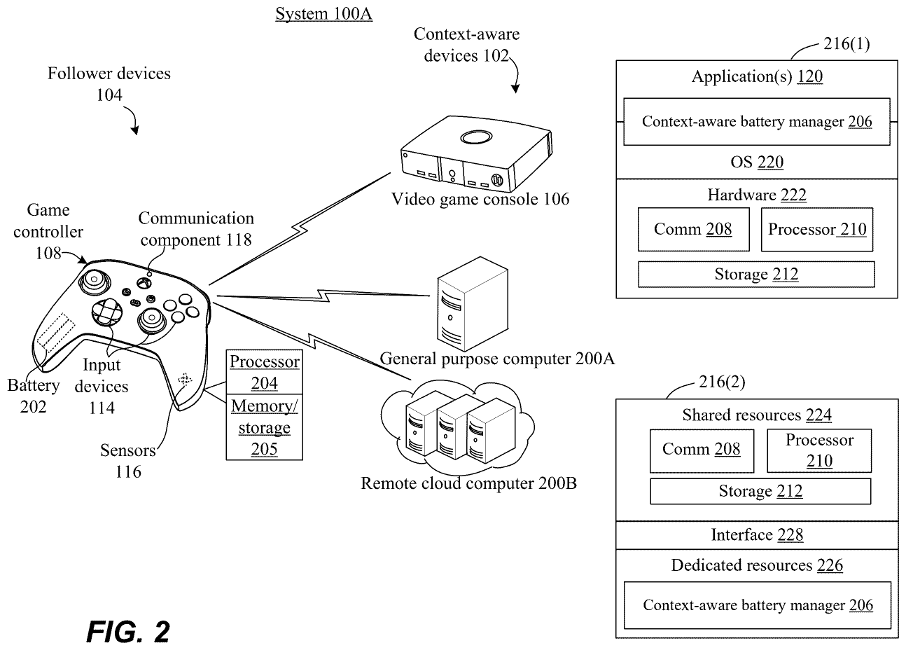

FIG. 2 shows another example system 100A, that is similar to system 100 introduced above relative to FIG. 1A. System 100A can include context-aware devices 102 and follower devices 104. In the illustrated configuration, context-aware devices 102 are manifest as video game console 106, a general purpose computer 200A, and a remote cloud computer 200B. The remote cloud computer 200B can provide a remote gaming service to the follower devices 104. Follower devices 104 are represented by game controller 108.

The game controller 108 includes input devices 114, sensors 116, communication component 118, a battery 202, a processor 204 and memory/storage 205. The input devices can include various switches, toggles, buttons, rollers, trackpads, etc. that are configured to convert user input to electrical signals. The sensors 116 can include various accelerometers, gyroscopes, six-axis sensors (e.g., 6 DoF sensor), etc. that are configured to sense movement, orientation, and/or location of the game controller 108. The communication component 118 can include components and circuitry for communicating in accordance with one or more wireless technologies, such as Bluetooth, Wi-Fi, etc.

The battery 202 can be a standard or rechargeable battery configured to store and deliver power for functioning of the game controller 108. The processor 204 coordinates the function of the other components of the follower device 104 (e.g., the input devices 114, sensors 116, communication component 118, and battery 202). The processor 204 can coordinate the control of the other components via sets of parameter values received from the context-aware device 102.

The processor 204 can control the function of the other components (e.g., the input devices 114, sensors 116, communication component 118 and battery 202) in a binary manner (e.g., either off or on). However, other implementations can have more than two control states. For example, the processor 204 may control the communication component 118 among several possible options from ‘on’ (e.g., powered on) through a range of polling rates, such as from 0.001 seconds, 0.01, 0.1 to 1.0 seconds, (e.g., predetermined extended sleeping time) to powered ‘off’. Further the processor 204 could control the communication component 118 asymmetrically. For instance, under one set of parameters, the communication component 118 may not transmit any data but may periodically sense to receive data, such as once per second. The received data may contain a second set of parameter values that are received by the communication component 118 and interpreted by the processor 204. Responsively, the processor 204 can cause the communication component 118 to send and/or receive signals at a faster rate (e.g., higher or faster polling rate). (As used herein, ‘and/or’ means that any listed element can occur, all listed elements can occur, or any sub-combination of at least one listed element can occur). Note also that the parameter values may relate to the processor 204 itself. For instance, the processor could be operated at a faster rate (e.g., clock speed) during active periods than during inactive periods.

In another example, the parameter values for individual input devices 114 can be different from each other. For example, an individual input device may be assigned a sampling interval parameter value of about 250 milliseconds (ms) while different individual input device may be assigned a sampling interval parameter value of about 1000 ms while still another different input device is turned off or otherwise ignored (e.g., not communicated to the context aware device until a signal is received from one of the two former input devices and communicated to the context aware device).

Note that some communications protocols detect loss of communication by lack of input for a time. The context-aware device 102 can alter a timeframe for expected receipt of an update from a follower device 104, preventing it from appearing disconnected during a low-power state (e.g., if normally requiring a transmission every 60 ms (or missing no more than 5×10 ms transmission timeslots), can instead be every 1 s when update timeframe of the follower device is set to 200 ms (as one example)).

The memory 205 can include default parameter values (e.g., specifications) for the follower device 104. In such configurations, the parameter values received from the context-aware device may have a defined time duration, such as 10 seconds, for example. The time duration could be defined in the specifications on the follower device and/or be defined on the received parameter values themselves. In such a configuration, if new parameter values are not timely received, the previously received parameter values automatically expire after the defined time. The processor 204 then reverts to the default parameter values. This configuration reduces the likelihood of stale and inappropriate parameter values being employed on the follower device, such as might otherwise occur if the application crashes or has bugs. Thus, the follower device reverts to a standard but functional state.

The processor 204 can control the input devices 114 and the sensors 116 in a similar manner. For instance, the processor 204 can determine a uniform state for all of the input devices 114. Alternatively, the processor 204 may turn off some of the input devices 114 while leaving others on. For instance, one of the input devices 114 may allow for a user to override the inactive state if the user wants to restore full function to the game controller 108. The processor 204 can keep that input device active while inactivating others. Similarly, the processor 204 can control all of the sensors 116 the same way or control some different than others. For example, the processor 204 may keep accelerometers active at a reduced sensing rate and inactivate other sensors. This would allow the accelerometers to sense a ‘shake awake’ action by the user, which could be interpreted by the processor 204 and/or by the context-aware device 102 as an indication to change the state of the game controller 108 to a more active state.

In some configurations, the above example can be implemented via multiple power domains. Individual power domains can be associated with individual follower device functionalities. Thus, individual power domains can be discretely and independently controlled by the processor 204. For instance, analog sensing can be one power domain (e.g., triggers, joysticks, etc.), while on/off buttons have a separate power domain. The power domains can map to hardware that allows to power down analog-to-digital conversion (ADC), or has an ultra-low power portion of the processor (e.g., microcontroller) that can interrupt on digital inputs at a lower power state than if doing analog conversions).

The processor 204 can control the input devices 114, sensors 116, and the communication component 118 at a relatively slow power saving state according to a set of parameter values received from the context-aware device 102. The communication component 118 could receive a new set of parameter values from the context-aware device 102 that includes more responsive, but more power consuming parameter values. The processor 204 can implement the new set of parameter values to enhance the functionality of the game controller 108.

At the hardware level, the processor 204 can control the follower device in various ways. For instance, in some cases, the processor can use a lowest latency requirement (e.g., 250 ms) for all enabled inputs. In other cases, the processor can reduce power/disable unused inputs entirely (presuming independent power domain). In still other cases, the processor can enable power to inputs only when one of the latency timers fire (input needed from that input type) and then disabling when no longer needed/sleeping. For multiprocessor systems, power up/down of power domains can use traditional reference-counting style options, as one example, to ensure power domains are active when sampling input.

Context-aware devices 102 can include a context-aware battery manager 206, a communication component 208, a processor 210, and storage resources (e.g., storage) 212. Context-aware devices 102 communicate with the follower devices 104 via communication components 208. The communication component 208 may communicate with other devices, such as cloud-based devices, via wired or wireless technologies.

The context-aware battery manager 206 can be configured to monitor the application 120 (e.g., an interactive application like a video game). The context-aware battery manager 206 can proactively identify active periods where a user interacts with a presentation of the interactive application. The context-aware battery manager 206 can also proactively identify inactive periods where the user does not interact with the game presentation. These inactive periods may be produced by the application 120. For instance, the application may present introductions, cutscenes, authorship and ownership information, etc. that offer reduced levels of interaction or no interaction. Some inactive periods may be externally induced. For instance, internet bandwidth issues may delay the application obtaining needed information to such a degree that the game is effectively paused until the information is obtained. The context-aware battery manager 206 can identify this occurrence as an inactive period.

In some implementations, the context-aware battery manager can identify two types of events. The two types of events include flagged events and inferred events.

Flagged events can be created by the developers of the application to intentionally flag elements of the application experience such as introductions, loading screens, cutscenes, authorship and ownership information, etc. into a specific activity category (in this case, inactive period). The context-aware battery manager can deploy a specific set of parameter values when encountering flagged events.

Inferred events occur when the context-aware device experiences an event of known limited user input such as limited bandwidth, updates, bootup, diagnostic tests, loading screens, etc. There can be overlaps between the two events because an application developer can choose to manually flag the event for a specific parameter set or rely on the inherent detection rules of the context-aware battery manager to automatically infer periods of limited user input.

The context-aware battery manager 206 can generate sets of parameter values that control the operation of the follower devices 104 in accordance with the state of the application 120 (e.g., active period or inactive period). An appropriate set of parameter values for a present or approaching period can be sent by the communication component 208 to the follower device's communication component 118. As mentioned above, the follower device's processor 204 can implement the set of parameter values on the follower device 104. This provides a technical solution that allows high performance from the follower devices 104 during interactive (e.g., active) periods and yet reduces power consumption during inactive periods without negatively impacting the performance of the follower devices 104 during the active periods. These changes are made proactively and dynamically without any user distraction or effort. Essentially, the source of the power savings is imperceptible to the user.

FIG. 2 shows two device configurations 216 that can be employed by context-aware devices 102. Context-aware devices 102 can employ either configuration 216(1) or 216(2), or an alternate configuration. (Due to space constraints on the drawing page, one instance of each configuration is illustrated). Briefly, device configuration 216(1) represents an operating system (OS) centric configuration. Device configuration 216(2) represents a system on a chip (SOC) configuration. Device configuration 216(1) is organized into one or more applications 120, operating system 220, and hardware 222. Device configuration 216(2) is organized into shared resources 224, dedicated resources 226, and an interface 228 therebetween.

In configuration 216(1), the context-aware battery manager 206 can be manifest as part of the operating system 220. Alternatively, the context-aware battery manager 206 can be manifest as part of the applications 120 that operates in conjunction with the operating system 220 and/or processor 210. In configuration 216(2), the context-aware battery manager 206 can be manifest as part of the processor 210 or a dedicated resource 226 that operates cooperatively with the processor 210.

The term “device,” “computer,” or “computing device” as used herein can mean any type of device that has some amount of processing capability and/or storage capability. Processing capability can be provided by one or more processors that can execute data in the form of computer-readable instructions to provide functionality. Data, such as computer-readable instructions and/or user-related data, can be stored on/in storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 216(2) can be viewed as a system on a chip (SOC) type configuration. In such a case, functionality provided by the device can be integrated on a single SOC or multiple coupled SOCs. One or more processors 210 can be configured to coordinate with shared resources 224, such as storage 212, etc., and/or one or more dedicated resources 226, such as hardware blocks configured to perform certain specific functionality. Thus, the term “processor” as used herein can also refer to central processing units (CPUs), graphical processing units (GPUs), field programmable gate arrays (FPGAs), controllers, microcontrollers, processor cores, hardware processing units, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU, CPUs, GPU or GPUs). The program code can be stored in one or more computer-readable memory devices, such as computer-readable storage media. The features and techniques of the components are platform-independent, meaning that they may be implemented on a variety of commercial computing platforms having a variety of processing configurations.

Note, in some implementations the instructions to the follower devices can be manifest as commands. For instance, the instructions can command an individual follower device to operate according to the first set of parameter values and then at the second set of parameter values. In other implementations, the instructions can be informational. For instance, the instructions may indicate that the application running on the context-aware device only needs a specific level of performance from the follower device as defined in the set of parameter values. However, in these implementations, if the follower device is also performing functions for another application or device that needs higher performance, the follower device may elect to implement parameter values to satisfy the higher performance requirement of the two functions. In another configuration, the follower device could revert to default specifications if it receives contradictory parameter values.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable medium” can include signals. In contrast, the term “computer-readable storage medium” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

### Example Methods

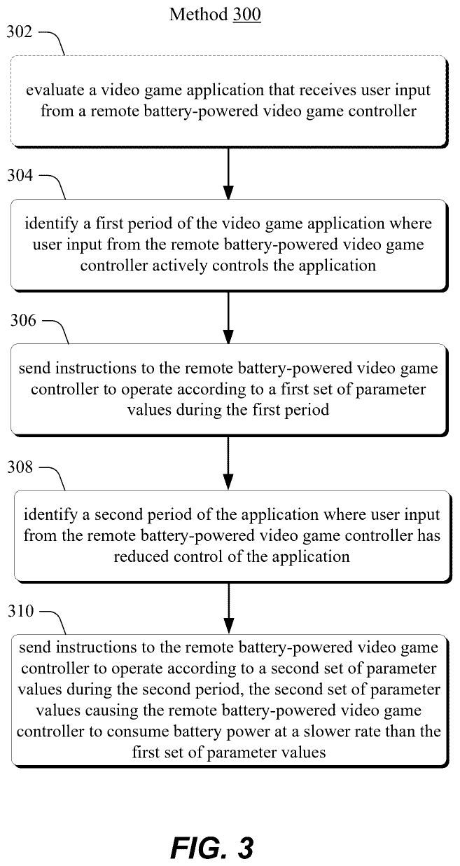

FIG. 3 illustrates an example power saving method 300, consistent with some implementations of the present concepts. This is a device implemented method. For instance, the method can be stored on a computer-readable storage media as a set of instructions that can be executed by a processor.

At block 302 the method evaluates a video game application that receives user input from a remote battery-powered video game controller. As used in this method the term ‘remote’ in relation to the remote battery-powered video game controller conveys that the remote battery-powered video game controller is not the device or a part of the device that is running the video game application. Instead, the remote battery-powered video game controller is a separate device that is in communication with the device running the video game application.

At block 304 the method identifies a first period of the video game application where user input from the remote battery-powered video game controller actively controls the application. In some cases, the identifying is performed proactively (e.g., before the first period begins). As mentioned above, in some implementations, the application can be hard coded to provide notice of events (e.g., flagged events) that relate to the status of the application (e.g., active or inactive).

At block 306 the method sends instructions to the remote battery-powered video game controller to operate according to a first set of parameter values during the first period.

At block 308 the method identifies a second period of the application where user input from the remote battery-powered video game controller has reduced control of the application. For instance, the second period may be associated with the application establishing an internet connection and configuring a play configuration, such as finding suitable opponents and/or teammates. During this time, the users (e.g., their game characters) may wait in a lobby until commencement of the active period. Other inactive periods include presentation of credits, loading screens, initial startup prior to first interactive state (i.e., “logo parade”), etc.

In some scenarios, the application generally only uses a limited set of the inputs. For example, if only the left/right on the D-pad and the “A” button are used: the application could be configured to send a configuration that enables powering down one or more of the unused inputs (analog joysticks, analog triggers, shoulder buttons, “B”, “X”, “Y” buttons, etc.) for extended periods of time that the application is running.

In some cases, the identification of a second period can occur before the second period begins. For instance, the method can identify that the user (e.g., game player) is nearing the end of a game level and that there is an inactive period between the current level and the next level. The method can prepare to send instructions right at the completion of the current level. Alternatively, because there typically is memory onboard follower devices, instead of preparing to send at the moment of completion, it can be sent prior to that moment and primed on the follower device to trigger when the moment occurs as well to avoid unexpected latency or other delays. Other scenarios may occur which cannot be proactively identified. For instance, the application could be receiving remote game content, such as from a cloud server, and the internet connection could be interrupted so that the content is delayed. The method can recognize this as a transition from the active period to an inactive period until the internet connection is restored and the remote game content is received.

At block 310 the method sends instructions to the remote battery-powered video game controller to operate according to a second set of parameter values during the second period. The second set of parameter values cause the remote battery-powered video game controller to consume battery power at a slower rate than the first set of parameter values. For instance, in one example the second set of parameter values may indicate a 1.0 second (slower) polling rate for the game controller compared to a much faster 0.001 polling rate during active periods. In another example the second set of parameter values may indicate a 2.0 second (slower) polling rate for the remote battery-powered video game controller compared to a much faster 0.008 polling rate during active periods. In still another example the second set of parameter values may indicate a 10.0 second (slower) polling rate for the game controller compared to a much faster 0.01 second polling rate during active periods.

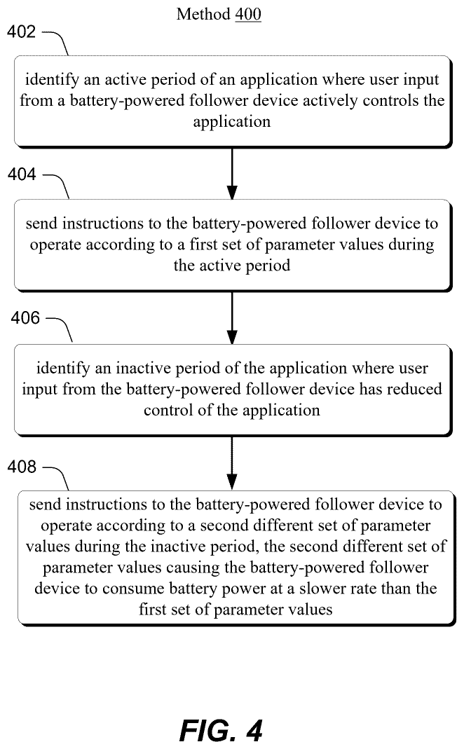

FIG. 4 illustrates another example power saving method 400, consistent with some implementations of the present concepts.

At block 402 the method identifies an active period of an application where user input from an individual battery-powered follower device actively controls the application. For instance, the game player may fly a fighter jet through a canyon while battling adversaries. The content presented and whether the game character lives or dies depends on the user input. This can be viewed as an active period. Then the game player's fighter jet may need ‘in flight’ refueling where once connected to the refueler, the fighter plane automatically flies in a straight line until the user requests the refueling be stopped and the refueling boom to be disconnected (e.g., retracted), such as if the jet is full. The former can be an active period and the latter can be an inactive period.

At block 404 the method sends instructions to the battery-powered follower device to operate according to a first set of parameter values during the active period. In the above example, low latency is important in the close quarters flying and shooting in the canyon. In such a case, the user enters large numbers and types of inputs to the application in a short amount of time.

At block 406 the method identifies an inactive period of the application where user input from the individual battery-powered follower device has reduced control of the application. Low latency is not as important during the refueling process. The user inputs fewer inputs of less types in a given amount of time. Thus, the polling rate of input devices on the follower devices can be slower and/or the transmission rate from the follower device to the context aware device can be slower. The receive rate that the follower device listens for instructions from the context aware device can be slower. Any one or all of these changes can conserve battery power compared to the active state.

At block 408 the method sends instructions to the battery-powered follower device to operate according to a second different set of parameter values during the inactive period, the second different set of parameter values causing the battery-powered follower device to consume battery power at a slower rate than the first set of parameter values. This allows power to be consumed at a slower rate than the first set of parameter values while providing the same or similar user experience because the power savings occurs when the user is not controlling the game or is controlling the game in a less time sensitive manner during the power savings.

Although the subject matter has been described in language specific to structural features and/or methodological acts relating to matching power usage on follower devices to a level of user interaction, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

### ADDITIONAL EXAMPLES

Various examples are described above. Additional examples are described below. One example includes a system comprising a processor configured to identify active periods in a video game application where a player interacts with a game presentation and inactive periods where the player does not interact with the game presentation and a communication component configured to proactively instruct a battery-powered video game controller to operate according to a first set of parameter values during the identified active periods that cause the battery-powered video game controller to use a relatively higher amount of power and to instruct the battery-powered video game controller to operate according to a second set of parameter values during the identified inactive periods that cause the battery-powered video game controller to use a relatively lower amount of power.

Another example can include any of the above and/or below examples where the processor is configured to identify an individual active period before the individual active period occurs or to identify an individual inactive period before the individual inactive period occurs.

Another example can include any of the above and/or below examples where parameters in the first and second sets of parameter values relate to a polling rate at which user input is detected on the battery-powered video game controller, sensors, and input devices on the game controller.

Another example can include any of the above and/or below examples where the identified inactive periods comprise cutscenes or intervals between levels where the player is not controlling a game character with the battery-powered video game controller.

Another example can include any of the above and/or below examples where the identified inactive periods comprise intervals between levels where the player is controlling a game character with reduced control options compared to the active periods.

Another example can include any of the above and/or below examples where the identified active periods comprise periods where the player is actively controlling a game character with more control options than the inactive periods.

Another example can include any of the above and/or below examples where the reduced control options comprise responding to fewer than all inputs from all of the input devices of the battery-powered video game controller, the second set of parameter values permitting the battery-powered video game controller to power down one or more of the unused inputs.

Another example can include any of the above and/or below examples where the first set of parameter values includes a faster polling rate for communications from the battery-powered video game controller and the second set of parameter values includes a slower polling rate for communications from the battery-powered video game controller.

Another example can include any of the above and/or below examples where the first set of parameter values includes active states for all input devices and sensors on the battery-powered video game controller and the second set of parameter values includes inactive states for all input devices and sensors on the battery-powered video game controller.

Another example can include any of the above and/or below examples where the system comprises a video game console or a general-purpose computer that includes the processor and the communication component and the battery-powered video game controller or where the system comprises a video game console or a general-purpose computer that includes the processor and the communication component and does not include the battery-powered video game controller.

Another example can include a context-aware device comprising a processor configured to run an interactive application and to proactively identify active periods where a user interacts with a presentation of the interactive application and inactive periods where the user does not interact with the presentation and a communication component configured to send a first set of parameter values to a follower device for use during the identified active periods and to send a second set of parameter values to the follower device during the identified inactive periods that cause the follower device to use a relatively lower amount of power.

Another example can include any of the above and/or below examples where the interactive application comprises a video game application or an entertainment application.

Another example can include any of the above and/or below examples where the context-aware device comprises a general-purpose computer, or wherein the context-aware device comprises a video game console.

Another example can include any of the above and/or below examples where the inactive periods comprise cutscenes, credits, and/or commercials.

Another example can include any of the above and/or below examples where the inactive periods do not allow any user interaction or where the inactive periods allow reduced user interaction compared to the active periods.

Another example can include any of the above and/or below examples where the follower device comprises multiple follower devices.

Another example can include any of the above and/or below examples where the follower device comprises a device selected from the group consisting of a game controller, a headset, and a display.

Another example can include a computer-readable storage medium storing instructions which, when executed by a computing device, cause the computing device to perform acts comprising evaluating a video game application that receives user input from a remote battery-powered game controller, identifying a first period of the video game application where user input from the remote battery-powered game controller actively controls the application, sending instructions to the remote battery-powered game controller to operate according to a first set of parameter values during the first period, identifying a second period of the application where user input from the remote battery-powered game controller has reduced control of the application, and sending instructions to the remote battery-powered game controller to operate according to a second set of parameter values during the second period, the second set of parameter values causing the remote battery-powered game controller to consume battery power at a slower rate than the first set of parameter values.

Another example can include any of the above and/or below examples where identifying a first period occurs before the first period begins, and wherein identifying a second period occurs before the second period begins.

Another example can include any of the above and/or below examples where identifying a second period comprises identifying the second period where the application is waiting on external factors or wherein the identifying a second period comprises identifying the second period where the application is presenting content that is not user controllable.

Another example can include a computer-readable storage medium storing instructions which, when executed by a computing device, cause the computing device to perform acts comprising identifying an active period of an application where user input from a battery-powered follower device actively controls the application, sending instructions to the battery-powered follower device to operate according to a first set of parameter values during the active period, identifying an inactive period of the application where user input from the battery-powered follower device has reduced control of the application, and sending instructions to the battery-powered follower device to operate according to a second different set of parameter values during the inactive period, the second different set of parameter values causing the battery-powered follower device to consume battery power at a slower rate than the first set of parameter values.

Another example can include any of the above and/or below examples where the battery-powered follower device presents content from the application or where another battery-powered follower device presents content from the application.

Another example can include a device comprising a communication component configured to alternatively receive either a first set of parameter values associated with an active period where content is presented for a user and user input is expected to control the presented content or a second set of parameter values associated with an inactive period where content is presented for a user and a reduced level of user control is expected to control the presented content, the second set of parameter values consuming power at a reduced rate compared to the first set of parameter values and a processor configured to control the communication component according to the first set of parameter values during the active period and to control the communication component according to the second set of parameter values during the inactive period to reduce power consumption by the communication component in the inactive period compared to the active period.

1. A system comprising:
a processor configured to identify active periods in a video game application where a player interacts with a game presentation and inactive periods where the player does not interact with the game presentation; and,
a communication component configured to proactively instruct a battery-powered video game controller to operate according to a first set of parameter values during the identified active periods that cause the battery-powered video game controller to use a relatively higher amount of power and to instruct the battery-powered video game controller to operate according to a second set of parameter values during the identified inactive periods that cause the battery-powered video game controller to use a relatively lower amount of power.

2. The system of claim 1, wherein the processor is configured to identify an individual active period before the individual active period occurs or to identify an individual inactive period before the individual inactive period occurs.

3. The system of claim 1, wherein parameters in the first and second sets of parameter values relate to a polling rate at which user input is detected on the battery-powered video game controller, sensors, and input devices on the game controller.

4. The system of claim 1, wherein the identified inactive periods comprise cutscenes or intervals between levels where the player is not controlling a game character with the battery-powered video game controller.

5. The system of claim 4, wherein the identified inactive periods comprise intervals between levels where the player is controlling a game character with reduced control options compared to the active periods.

6. The system of claim 5, wherein the identified active periods comprise periods where the player is actively controlling a game character with more control options than the inactive periods.

7. The system of claim 5, wherein the reduced control options comprise responding to fewer than all inputs from all of the input devices of the battery-powered video game controller, the second set of parameter values permitting the battery-powered video game controller to power down one or more of the unused inputs.

8. The system of claim 1, wherein the first set of parameter values includes a faster polling rate for communications from the battery-powered video game controller and the second set of parameter values includes a slower polling rate for communications from the battery-powered video game controller.

9. The system of claim 5, wherein the first set of parameter values includes active states for all input devices and sensors on the battery-powered video game controller and the second set of parameter values includes inactive states for all input devices and sensors on the battery-powered video game controller.

10. The system of claim 1,
wherein the system comprises a video game console or a general-purpose computer that includes the processor and the communication component and the battery-powered video game controller, or,
wherein the system comprises a video game console or a general-purpose computer that includes the processor and the communication component and does not include the battery-powered video game controller.

11. A context-aware device, comprising:
a processor configured to run an interactive application and to proactively identify active periods where a user interacts with a presentation of the interactive application and inactive periods where the user does not interact with the presentation; and,
a communication component configured to send a first set of parameter values to a follower device for use during the identified active periods and to send a second set of parameter values to the follower device for use during the identified inactive periods that cause the follower device to use a relatively lower amount of power.

12. The device of claim 11, wherein the interactive application comprises a video game application or an entertainment application.

13. The device of claim 11, wherein the context-aware device comprises a general-purpose computer, or wherein the context-aware device comprises a video game console.

14. The device of claim 11, wherein the inactive periods comprise cutscenes, credits, and/or commercials.

15. The device of claim 14,
wherein the inactive periods do not allow any user interaction, or
wherein the inactive periods allow reduced user interaction compared to the active periods.

16. The device of claim 11, wherein the follower device comprises multiple follower devices.

17. The device of claim 16, wherein the follower device comprises a device selected from the group consisting of a game controller, a headset, and a display.

18. A computer-readable storage medium storing instructions which, when executed by a computing device, cause the computing device to perform acts comprising:
evaluating a video game application that receives user input from a remote battery-powered video game controller;
identifying a first period of the video game application where user input from the remote battery-powered video game controller actively controls the application;
sending instructions to the remote battery-powered video game controller to operate according to a first set of parameter values during the first period;
identifying a second period of the application where user input from the remote battery-powered video game controller has reduced control of the application; and,
sending instructions to the remote battery-powered video game controller to operate according to a second set of parameter values during the second period, the second set of parameter values causing the remote battery-powered video game controller to consume battery power at a slower rate than the first set of parameter values.

19. The computer-readable storage medium of claim 18, wherein identifying a first period occurs before the first period begins, and wherein identifying a second period occurs before the second period begins.

20. The computer-readable storage medium of claim 18, wherein identifying a second period comprises identifying the second period where the application is waiting on external factors or wherein the identifying a second period comprises identifying the second period where the application is presenting content that is not user controllable.
